(19) United States
(12) Patent Application Publication
(10) Pub. No.: US 2026/0044648 A1
(43) Pub. Date: Feb. 12, 2026

(54) SYSTEMS AND METHODS FOR RECOVERING IMPLICIT PHYSICS MODEL UNDER REAL WORLD CONSTRAINTS

(71) Applicants: Ayan Banerjee, Gilbert, AZ (US); Sandeep Gupta, Phoenix, AZ (US)

(72) Inventors: Ayan Banerjee, Gilbert, AZ (US); Sandeep Gupta, Phoenix, AZ (US)

(73) Assignee: Arizona Board of Regents on Behalf of Arizona State University, Tempe, AZ (US)

(21) Appl. No.: 19/292,069

(22) Filed: Aug. 6, 2025

Related U.S. Application Data
(60) Provisional application No. 63/681,094, filed on Aug. 8, 2024.

(51) Int. Cl. G06F 30/27; G06F 17/13; G06F 111/10; G06N 3/0499; G06N 3/08

(52) U.S. Cl. CPC G06F 30/27; G06F 17/13; G06N 3/0499; G06N 3/08; G06F 2111/10

(57) ABSTRACT

Examples including a system described herein implement a novel liquid time constant neural network (LTC-NN) based architecture to recover an underlying model of physical dynamics from real world data. The automatic differentiation property of LTC-NN nodes overcomes problems associated with low sampling rate, the input dependent time constant in the forward pass of the hidden layer of LTC-NN nodes creates a massive search space of implicit physical dynamics, the physics model solver based data reconstruction loss guides the search for the correct set of implicit dynamics, and drop out in dense layer ensures extraction of the sparsest model. Further, to account for perturbation timing error, the LTC-NN based architecture of the system utilizes dense layer nodes to search through input shifts that results in the lowest reconstruction loss.

### CROSS REFERENCE TO RELATED APPLICATIONS

This is a non-provisional application that claims benefit to U.S. Provisional Patent Application Ser. No. 63/681,094 filed on Aug. 8, 2024, which is herein incorporated by reference in its entirety.

### FIELD

The present disclosure generally relates to model recovery for dynamical systems, and in particular, to a system and associated methods for recovering an implicit physics model for a dynamical system under real-world constraints.

### BACKGROUND

In practical deployment, dynamical systems suffer from sampling constraints where data may be sampled at or below Nyquist rate. Hence, model recovery (MR) techniques are required to provide good generalization performance (MR error on unseen traces) with low sampling rates. However, at sub-Nyquist rate, full information about model coefficients is not embedded in the traces, hence model recovery techniques should incorporate external knowledge such as sparsity structure of the non-linear dynamics to target reduction in model coefficient estimation error. Further, input timing errors are commonly encountered in real-world dynamical systems but are difficult to model under sparse observation constraints. Modeling potential input perturbations can easily become computationally intractable and inaccurate as current techniques tend to compensate through techniques such as including more variables that are differentials of input observations.

It is with these observations in mind, among others, that various aspects of the present disclosure were conceived and developed.

### BRIEF DESCRIPTION OF THE DRAWINGS

FIG. 1 is a simplified diagram showing a system for implicit physics model recovery that incorporates a modified Liquid Time Constant neural network (LTC-NN) architecture;

FIG. 2 is a simplified diagram showing an example implementation of neural architecture based model recovery solution with input uncertainty;

FIGS. 3A-3D are a series of graphical representations showing comparison of SINDYc with neural architecture for configuration Φ_{N} by only varying sampling frequency to Nyquist rate, no implicit dynamics, with perturbation, and no input uncertainty, where FIG. 3A shows results for a Lotka Volterra system, FIG. 3B shows results for a Chaotic Lorenz system, FIG. 3C shows results for an F8 Crusader system, and FIG. 3D shows results for a pathogenic attack system; and

FIGS. 4A-4H are a series of graphical representations showing Comparison of SINDYc with neural architecture for configuration Φ_{N1} by sampling at Nyquist rate, no implicit dynamics, with/without perturbation, and no input uncertainty, where FIG. 4A shows RMSE_{θ} for a Lotka Volterra system, FIG. 4B shows RMSE_{Y} for the Lotka Volterra system, FIG. 4C shows RMSE_{θ} for a Chaotic Lorenz system, FIG. 4D shows RMSE_{Y} for the Chaotic Lorenz system, FIG. 4E shows RMSE_{θ} for an F8 Crusader system, FIG. 4F shows RMSE_{Y} for the F8 Crusader system, FIG. 4G shows RMSE_{θ} for a pathogenic attack system, and FIG. 4H shows RMSE_{Y} for the pathogenic attack system; and

FIG. 5 is a simplified block diagram showing an example computing device that can be used to implement aspects of the systems and methods outlined herein, such as the model recovery system of FIG. 1.

Corresponding reference characters indicate corresponding elements among the view of the drawings. The headings used in the figures do not limit the scope of the claims.

### DETAILED DESCRIPTION

Recovering physics driven governing equations of dynamical systems from real world data has been of recent interest. Most methods either operate on simulation data with unrealistically high sampling rates or require explicit measurements of all system variables, which is not amenable in real-world deployments. Moreover, existing techniques assume that the time stamps of external perturbations to the physical system are known apriori without uncertainty, implicitly discounting any sensor time synchronization or human reporting errors.

The present disclosure outlines a system that includes a novel liquid time constant neural network (LTC-NN) based architecture to recover underlying model of physical dynamics from real world data. The automatic differentiation property of LTC-NN nodes overcomes problems associated with low sampling rate, the input dependent time constant in the forward pass of the hidden layer of LTC-NN nodes creates a massive search space of implicit physical dynamics, the physics model solver based data reconstruction loss guides the search for the correct set of implicit dynamics, and drop out in dense layer ensures extraction of the sparsest model. Further, to account for perturbation timing error, the LTC-NN based architecture of the system utilizes dense layer nodes to search through input shifts that results in the lowest reconstruction loss. Experiments on four benchmark dynamical systems, three with simulation data and one with real world data show that the LTC-NN architecture is more accurate in recovering implicit physics model coefficients than state-of-the-art sparse model recovery approaches. The present disclosure also introduces four additional case studies (total eight) on real-life medical examples in simulation and with real-world clinical data to show effectiveness of the system in recovering underlying model in practice.

### 1 Introduction

Model recovery problem concerns with deriving underlying physics driven governing equations of a system from data. Different from model learning, the model recovery has two goals: a) to accurately reconstruct the data, and b) derive the fewest terms required to represent the underlying non-linear dynamics. As such sparse identification of non-linear dynamics is needed. It is useful for several applications such as learning digital twins, safety analysis, anomaly detection, explainable artificial intelligence (AI) and prediction. Two broad categories of techniques exist (Table 1): a) using physics driven deep learning on large datasets, and b) using transformations that linearize the non-linear dynamics using Koopman theory and then performing linear regression with sparsity constraints. It is generally acknowledged that both categories of techniques suffer significant performance degradation on data from real world systems. Some effort has been undergoing to improve performance of both categories of approaches on systems with limited data and noise, however, such problems are only a small subset of issues observed in real world deployments.

The present disclosure focuses on model recovery problem that arises in real world systems which may include interactions from human users in the runtime. As such, a control affine system whose n dimensional state space X={x₁ . . . xₙ}∈ [symbol] is given by:

$$\dot{X} = f ( X , Θ ) + g ( X , Θ ) ( U + {U}_{ex} ) , \qquad ( 1 )$$

where f(X, Θ): [symbol] × [symbol] → [symbol] is a model of the natural unperturbed dynamics of the physical system with human users in it that is perturbed by: a) an autonomous system U= [symbol] (X), where [symbol] : [symbol] → [symbol] is a control function that generates the m dimensional actuation signals to the physical system; and b) input from the human user Uₑₓ∈ [symbol] . The total perturbation is denoted as U_{T}=U+Vₑₓ· [symbol] (X, Θ): [symbol] × [symbol] → [symbol] , which expresses the effect of the input perturbation to the physical dynamics. Θ is a set of coefficients for the model of the dynamical system.

Real-world observations are limited by additional constraints (Ci).

C1: Low sampling rate—Storage and energy constraints in real world deployments often limit sensing frequency. According to Nyquist Shannon sampling theory, full information about model coefficients Θ is available in observation X if it is sampled at Nyquist rate i.e., sensing frequency is twice the maximum frequency in the power spectrum of X obtained from the solution of Eqn 1. The control input U is assumed to have the same sampling frequency as X. However, in practice, sensors often log data at sub-Nyquist rate.

Difficulty in model recovery with C1: Low sampling frequency causes performance degradation of model recovery. As samples grow further apart in time, the set of non-linear functions that accurately fit the samples becomes larger making it increasingly difficult to find the correct underlying model in the expanded search space.

C2: Perturbed system-Since in deployment the system operation cannot be disrupted, the traces X are always from a perturbed system following Eqn 1 and there is no trace obtained from the unperturbed part of the system. In addition, there can be external human inputs Uₑₓ that are sparse in time and is described by a set of tuples

$$Ex = \{ ( {U}_{ex}^{1} , {t}_{1} ) , … ( {U}_{ex}^{q} , {t}_{q} ) \} ,$$

denoting q external user inputs at times t₁ . . . t_{q}, tᵢ∈ [symbol] , ∀i. Model recovery from perturbed systems with control inputs has been considered in literature, however, sparse external human inputs has largely been ignored.

Difficulty in model recovery with C2: While input perturbations due to control logic are Lipschitz continuous, external human inputs are discontinuous that introduce transients in the dynamical system. Traditional least square minimization based model recovery approach that ignores human inputs may erroneously introduce higher order non-linear terms in the underlying model due to such transients.

C3: Sparsity structure in high dimensional non-linear function space—The model in Eqn 1 is a physics driven model, which is derived from first principles. As such the algebraic structure S of the model in Eqn 1 is sparse in the non-linear function space. However, in real-life systems, the sparsity information is often unknown.

Difficulty in model recovery with C3: Sparsity requirements add additional constraints to the model coefficients θ leading to a constrained optimization problem which may be more complex than unconstrained versions. Solutions such as physics driven deep learning use original model coefficients in the loss function (Table 1), which is not available in real-world deployments.

C4: Implicit dynamics-Privacy requirements, cost of sensing, and resource constraints on storage results in measurements of only a subset of the system variables X in real world deployments. This constraint is expressed as a sensing matrix C, which is a diagonal matrix, where cᵢᵢ=1 if a sensor senses xᵢ and cᵢᵢ=0 if there is no sensor for xᵢ. Hence, only sampled traces of Y=CX are available as sensed data and some physics driven dynamics model is implicit. All actuation inputs U and user inputs Uₑₓ are sensed.

Difficulty in model recovery with C4: With implicit dynamics, the problem formulations of existing model recovery approaches fall apart. To solve this, existing techniques increase the state variable dimension by adding new variables that are differentials of measured state variables. This is referred to as weakly implicit dynamics. There are two problems with such approaches: a) in real world deployment differential computation can be inaccurate especially with low sampling rates, and b) to model non-linearity of unmeasured state variables, higher order differentials need to computed, which not only increases error but also significantly increases the dimensionality of the model recovery problem.

C5: Input uncertainty-Time stamps of input perturbations are uncertain in real world due to several reasons: a) faulty reporting by human user, and b) inputs and state variables are often measured by different sensors which may have uncertain differences in clock times. In other words, the measured human inputs

$${U}_{ex}^{s} = {U}_{ex} + {η}_{ex}^{u}$$

has unknown error

$${η}_{ex}^{u}$$

and the measured user input activation time

$${t}_{ex}^{s} = {t}_{ex} + {η}_{ex}^{t}$$

has unknown error

$${η}_{ex}^{t} .$$

Difficulty in model recovery with C5: Current approaches do not consider noise in time stamps and only focus on noise in magnitude. Incorporating temporal uncertainties can intractably increase the search space of the model recovery problem.

Given a set T of traces of Y, U, Uₑₓ over time, the systems outlined herein solve the model recovery problem to derive θₑₛₜ such that ∥θ−θₑₛₜ∥²<ϵ, for some ϵ>0 error limit. However, note that the original θ is unknown and cannot be used in the solution of the problem. Hence, the estimated model coefficients θₑₛₜ has to be utilized to first derive an estimated trace Yₑₛₜ and then ∥Yₑₛₜ−Y∥² can be used as objective function.

### 1.1 Approach and Contributions

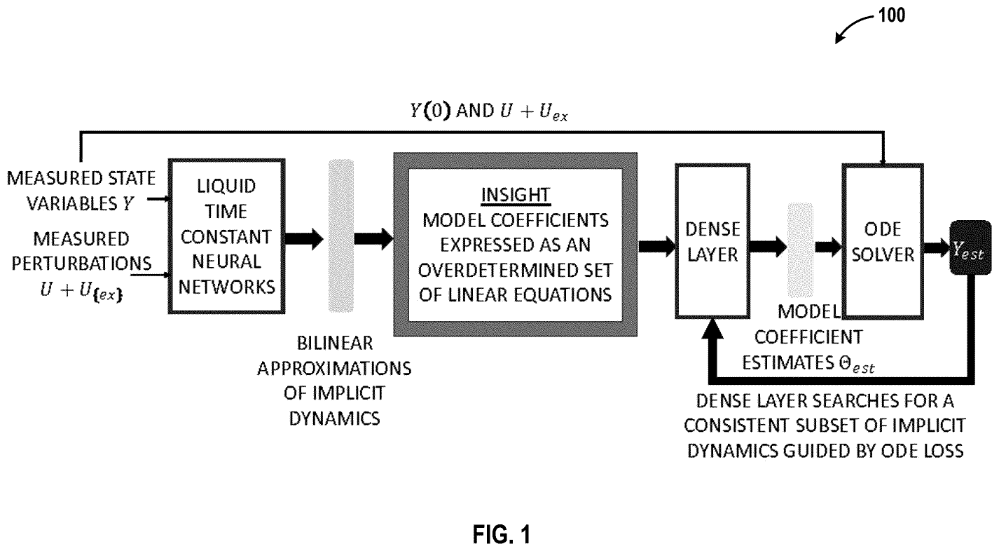

FIG. 1 shows a main contribution of the present disclosure: the extension of liquid time constant neural network (LTC-NN) to advanced neural structure (LTC-NN-MR) for recovering physics model under real world constraints, and implementation of a system 100 for recovering physics model under real world constraints using an LTC-NN-MR network.

Intuition for addressing C1: The automatic differentiation property of LTC-NN class of neural architectures which also include continuous time recurrent neural networks (CT-RNN) or neural ordinary differential equations (NODE) can solve a system of ODE with arbitrary temporal resolution. Hence, even if the data sampling rate is low, LTC-NN can accurately represent system dynamics with arbitrary precision in between samples while maintaining the structure of the underlying dynamics.

Intuition for addressing C2: The forward pass of LTC-NN has the same form as the control affine dynamics in Eqn. 1. Hence, each node inherently decouples the perturbed and un-perturbed dynamics of the system and learns them separately.

Intuition for addressing C3 & C4: The forward pass of LTC-NN can take the form of bilinear approximations of the implicit dynamics in Eqn. 1 and hence can search through the space of implicit dynamics (FIG. 1). The measurements of Y, can be used to convert the set of implicit dynamics to an overdetermined system of equations that are linear in terms of the model coefficients. As such an over-determined system of equation may have no solution unless either some equations are rejected or are expressed as linear superposition of other equations, a dense layer is utilized to search for a set of consistent equations to estimate model coefficients. The search process of the dense layer is guided by a loss function (ODE loss) that computes the mean square error between the reconstructed/estimated Yₑₛₜ using an ODE solver SOLVE (Y(0), θ, U+Uₑₓ) and the ground truth measurements of Y. The sparsity in the model is introduced by utilizing drop outs in the dense layer.

Intuition for addressing C5: From the dense layer, the system keeps m nodes whose outputs are used to shift the input data Uₑₓ. Such dense layer nodes can potentially search through a large set of input shifts due to synchronization or reporting errors that best fits the data.

Case study contribution: The present disclosure compares LTC-NN-MR with state-of-the-art nonlinear model recovery technique, SINDYc, and other baselines that use the same advanced architecture as LTC-NN-MR but use CT-RNN or NODE as neural nodes. Three simulation and one real world example are used for benchmark case studies. Further, two new medical benchmarks are introduced with automated insulin delivery (AID) system and electro-encephalogram (EEG) brain signal reconstruction using nonlinear oscillator models. For AID, a simulation benchmark is created using the Food and Drug Administration (FDA) approved UVA/PADOVA Type 1 Diabetes (T1D) simulator. LTC-NN-MR is also tested on real world clinical study using the publicly available LOIS-P dataset for pregnant women with T1D. In addition, a simulation benchmark is created for EEG reconstruction case study and LTC-NN-MR is tested on real world CHB-MIT Scalp EEG dataset. In summary, the present disclosure shows evaluation of the system on five simulation and three real world case studies.

### 2 Related Works

Table 1 summarizes the recent works for model recovery. In the linear domain, system identification techniques such as Ho Kalman or Eigen system realization algorithm (ERA) attempt to fit a linear model to data. Such techniques do not scale to non-linear dynamics, and do not preserve the sparsity structure (violates C3).

The seminal work on extracting non-linear model from data used stratified symbolic regression and genetic programming. This approach did not scale with dimension, and required measurement of all state variables (violates C4).

Significant breakthrough was achieved through introduction of sparse identification of non-linear dynamics (SINDy) that iteratively selects dominant candidate from a library of high dimensional nonlinear functions. The sparsity (constraint C3) was achieved through a sequential threshold ridge regression (STRidge) algorithm that iteratively determines the sparse solution utilizing hard thresholds (manual configuration parameter). The original technique assumed unperturbed system (violates C2 & C5), and required measurements of all state variables xᵢ (violates C4). Subsequently SINDy has been extended to tackle constraint C2 for control inputs in SINDYc, however, it still violates C5.

Attempts have been made to incorporate extraction of implicit models using the SINDy strategy, however, the unmeasured state variables are only limited to the differentials of the original state variables (“weakly implicit”). SINDy has been also extended to tackle uncertainty in state variables magnitude but extension to timing uncertainty has not been explicitly explored.

TABLE 1
Related works in model recovery. High in column 2 means greater than double the Nyquist rate, Low means at Nyquist rate.

| | | | | | | | |
|---|---|---|---|---|---|---|---|
| | C1: | C2: | C2: | C3: | C4: | C5: | |
| | Sampled | Control | Human | Sparse | Implicit | Input | |
| Approach | data | Perturbed | Perturbed | model | dynamics | uncertainty | Assumptions |

Earlier approaches on model learning

| | | | | | | | |
|---|---|---|---|---|---|---|---|
| Eigen system Realization | Low | Yes | No | No | Yes | Magnitude | Linear system |
| Genetic Algorithm | High | No | No | Yes | No | No | Low dimensional nonlinear |
| | | | | | | | systems |

Recent Approaches on model recovery Class 1: Sparse Identification

| | | | | | | | |
|---|---|---|---|---|---|---|---|
| SINDy | High | No | No | Yes | No | No | Known sparsity threshold and |
| | | | | | | | library of polynomial functions |
| SINDYc | High | Yes | No | Yes | Weak | Magnitude | Known sparsity threshold and |
| | | | | | | | library of polynomial functions |
| E-SINDY | Low | Yes | No | Yes | ″ | ″ | Known sparsity threshold and |
| | | | | | | | library of polynomial functions |

Recent Approaches on model recovery Class 2: Physics guided deep learning

| | | | | | | | |
|---|---|---|---|---|---|---|---|
| NODE + metriplectic | High | No | No | Yes | No | No | Known metriplectic structure |
| structure | | | | | | | |
| PINNs + Sparse | Low | No | No | Yes | No | No | Physics loss for original |
| Regression | | | | | | | coefficients |
| Present System | Low | Yes | Yes | Yes | Yes | Yes | Black box ODE solver in the |
| (w/ LTC-NN-MR) | | | | | | | loss |

Physics informed Neural Networks (PINN) utilize the concept of automatic differentiation to perform accurate forward and inverse such models are black box and cannot provide θₑₛₜ while maintaining the constraints C3 and C4. Recently, PINNs have been integrated with sparse regression to recover model coefficients. Such approaches are not applied for perturbed systems (violates C2, consequently C5), and do not consider implicit dynamics (C4). A major assumption in these approaches is the knowledge of physics loss for the original model coefficients θ. This is an impractical circular assumption since the original model coefficients are unknown in real world examples. Recently, NODE structure has been used for forecasting while maintaining metriplectic structures, i.e., algebraic structures in models induced by laws of physics such as energy conservation, first and second law of thermodynamics. Such approaches violate C1, with unrealistically high sampling rates, violates C2 (and C5) since it uses unperturbed system, and violates C4 no implicit dynamics.

How is this system different? The system addresses the model recovery problem in the real world satisfying constraints C1 through C5:

Given: i) A set of sampled trace [symbol] ={tᵢ}, where

$${t}_{i} = \{ ( Y ( 0 ) , U ( 0 ) ) … ( Y ( k τ ) , U ( k τ ) ) \} ⋃ \{ ( {U}_{ex}^{1} , {t}_{1} ) , … ( {U}_{ex}^{q} {t}_{q} ) \} ,$$

where k is the number of samples and τ is the Nyquist sampling rate. ii) a “black box” ODE Solver Yₑₛₜ=SOLVE (Y(0), Θₑₛₜ, U+Uₑₓ), that takes any Θₑₛₜ as input and solves the ODE describing the physics model to provide an estimated/reconstructed Yₑₛₜ.
Find: Θₑₛₜ such that ∥Y−SOLVE(Θₑₛₜ)|²≤ψ, for some ψ>0
Under: C1 through C5 constraints.

### 3 Theoretical Foundations

The forward pass of LTC-NN node is given by:

$$\dot{h} ( t ) = - h ( t ) / ρ + {f}_{NN} ( h ( t ) , I ( t ) , t , ω ) ( A - h ( t ) ) , \qquad ( 2 )$$

where h(t) is one hidden state of the LTC-NN, ρ is a time constant parameter, required to assist any autonomous system to reach equilibrium state. As such existence of the −h(t)/ρ is an important stability criteria as it ensures that the unperturbed physical system settles in time. f_{NN} is the computation function of each node and is a function of the hidden states, I(t) is the input to the LTC-NN, ω and A are architecture parameters.

Remark 1. The forward pass of an LTC-NN architecture generates a set of implicit physical dynamics that are equivalent to a bilinear approximations of the control affine autonomous system in Eqn. 1.

Supporting argument: Algebraic manipulation of the forward pass of LTC-NN architecture gives the structure of Eqn. 3 which allows an input dependent time constant

$$\frac{ρ}{1 + ρ {f}_{NN} ( h ( t ) , I ( t ) , t , ω )} .$$

$$\dot{h} ( t ) = - h ( t ) / \frac{ρ}{1 + ρ {f}_{NN} ( h ( t ) , I ( t ) , t , ω )} + {f}_{NN} ( h ( t ) , I ( t ) , t , ω ) ( A ) . \qquad ( 3 )$$

The stability criteria for any autonomous system requires the control affine model to have a time constant term as shown in Eqn. 4

$$\dot{X} = - X / ρ + {f}_{- ρ} ( X ) + g ( X ) {U}_{T} , \qquad ( 4 )$$

where ρ is the time constant of the system and f_{-ρ}(·) is the unperturbed dynamics after removing the time constant component.

Assuming that the autonomous system is a dynamic causal system, the bilinear approximation of the control affine system in Eqn. 4 results in Eqn. 5.

$$\begin{matrix}\dot{X} \approx - X / ρ + {f}_{- ρ} ( X ) + BX + {CU}_{T} + {\sum }_{j} {u}_{T}^{j} {D}^{j} X + H , \\ where B = \frac{\partial ( g ( X ) {U}_{T} )}{\partial X} , C = \frac{\partial ( g ( X ) {U}_{T} )}{\partial {U}_{T}} , and {D}^{j} = \frac{{\partial }^{2} ( g ( X ) {U}_{T} )}{\partial X \partial {u}_{T}^{j}} ,\end{matrix} \qquad ( 5 )$$

H is a constant. Rearranging Eqn. 5 results in a similar form as the LTC-NN forward pass in Eqn. 6.

$$\dot{X} \approx - X / ( \frac{ρ}{1 + ρ ( B + {\sum }_{j} {u}_{T}^{j} {D}^{j} )} ) + ( {f}_{- ρ} ( X ) + {CU}_{T} + H ) . \qquad ( 6 )$$

Eqn. 6 is observed to be in the same form as Eqn. 3 if the input to the LTC-NN I(t) is a concatenation of Y and U_{T}. The hidden layers of the LTC-NN model an inflated set of implicit dynamics which may include the unmeasured system variables of the physics model.

Remark 2. The inflated set of implicit dynamics modeled by LTC-NN induces an over-determined set of equations in the coefficients of the bilinear approximation of control affine model.

Supporting argument: The training process of LTC-NN fixes weights and instantiates the hidden layer outputs. The values of the unmeasured variables in X is estimated by the hidden state in each training step utilizing the forward pass and learned LTC-NN weights ω. Hence each forward pass provides an over-determined set of linear equations in the coefficients B, C, and D^{j}.

The original control affine model coefficients Θ are non-linear functions of the coefficients B, C, and D^{j}s, The dense layer is best suited for exploring a large set of possible non-linear combinations of B, C, and D^{j} that express Θ. An overdetermined system of equations is inconsistent and may be unsolvable. The dense layer guided by the ODE solver induced loss function (ODE Loss) learns a consistent set of linear equations in B, C, and D^{j} and also learns their non-linear combination to determine Θ.

### 3.1 Addressing C1: Sampled Data

Architectures that enable automatic differentiation such as CT-RNN, NODE, or LTC-NN are shown to be capable of simulating arbitrary sampling rates between two time samples of the real data through usage of state-of-art ODE solvers. Hence, such architectures are at a relative advantage over sparse identification mechanisms such as SINDy. The examples show that decreasing sampling rate up to the minimum required Nyquist rate reduces accuracy of model recovery for SINDy class of approaches but has little to no effect on CT-RNN, NODE or LTC.

### 3.2 Addressing C2: Perturbed System

The LTC-NN forward pass has an input dependent time constant. This helps in modeling the perturbed system as demonstrated by the equivalence of Eqn. 3 and 6. This is not the case for other neural architecture with automatic differentiation such as CT-RNN or NODE (Eqn. 7). They do not have a direct mapping to the bilinear approximation of the control affine system.

$$CT RNN : \dot{h} ( t ) = - \frac{h ( t )}{ρ} + {f}_{CT} ( h , l , t , {ω}_{CT} ) \qquad ( 7 )$$

$$NODE : \dot{h} ( t ) = {f}_{CT} ( h , l , t , {ω}_{CT} ) \qquad ( 8 )$$

### 3.3 Addressing C3: Sparsity Preservation

Sparsity preservation is achieved through the training loss function and dropouts in dense layer. PINNs and NODE achieve sparsity by integrating a “physics loss”. It uses the original model coefficients Θ in an ODE solver to determine the ground truth Y to compute the RMSE of the estimated Yₑₛₜ. While this approach is appropriate in simulation settings, it is not practical since the original model coefficient Θ is not available in the real world. The presented approach uses ODE loss which uses the estimated model coefficients Θₑₛₜ and initial value of measured variables Y(0) to compute the k-1 samples of Yₑₛₜ at times {τ, 2τ . . . kτ}. For this purpose, it uses a state-of-art ODE solver that implements the control affine structure of the autonomous system. It computes RMSE with the real data Y as loss. Hence, Θ is not used in the training of LTC-NN-MR.

### 3.4 Addressing C4: Implicit Dynamics

Remark 1 shows that LTC-NN forward pass can provide an inflated set of implicit dynamics. This is also true for CT-RNN, and NODE. LTC-NN has the advantage over all other techniques in that it can model implicit dynamics in presence of external inputs.

### 3.5 Addressing C5: Input Uncertainty

Input uncertainty is of two types: a) magnitude, and b) temporal. The magnitude uncertainty is inherently handled in neural architectures through the weight update process. To tackle timing uncertainty, a subset Δ:|Δ|=q of the dense layer outputs are transformed to the range [0, 1] using a sigmoid activation function. Each dᵢ∈Δ acts a shift operation for the input

$${u}_{ex}^{i} ∈ {U}_{ex} .$$

### Each Input

$${u}_{ex}^{i}$$

is shifted by the amount dᵢ×k and is used in the input layer as well as the ODE Solver in the loss function for each forward pass of the neural structure. The dense layer is used to search for the set of possibilities of input shifts due to temporal uncertainty.

### 4 Implementation

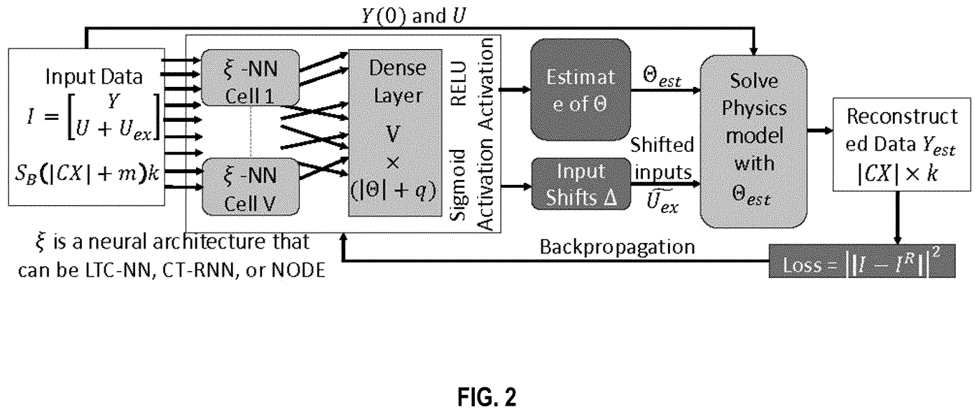

The advanced neural architectures for model recovery (ξ-MR, where ξ is either LTC-NN, CT-RNN, or NODE) (FIG. 2)]. For each example, the training data is extracted, including temporal traces of Y, U and Ex. Y is sampled at least at the Nyquist rate for the application, and U has the same sampling rate as Y. Ex is a set of tuples denoting

$${U}_{ex}^{i}$$

values at time

$${t}_{ex}^{i} .$$

Ex is transformed into a signal at the same sampling frequency as Y by keeping Uₑₓⁱ at times

$${t}_{ex}^{i}$$

and appending 0s at all other times. The resulting training data is then divided into batches of size S_{B} forming a 3D tensor of size S_{B}×(|Y|+m)×k.

Each batch is passed through the ξ network with V nodes, resulting in V hidden states. A dense layer is then employed to transform this V hidden states into p=|Θ| model coefficient estimates and q input shift values. The dense layer is a multi-layer perceptron with ReLU activation function for the model coefficient estimate nodes and sigmoid activation function for input shift values. The input shift values are used to shift the external input vector. The shifted inputs, the model coefficient estimates, and the initial value Y(0) is passed through an ODE solver, that solves the control affine model in Eqn. 1 with the coefficients Θₑₛₜ, initial conditions Y(0) and inputs U and Uₑₓ. The Runge Kutta integration method is used in the ODE solver, which gives Yₑₛₜ. The backpropagation of the network is performed using the network loss appended with ODE loss, which is the mean square error between the original trace Y and estimated trace Yₑₛₜ.

### 5 Evaluation

Experiments are performed in Nvidia Titan V GPU, CUDA 11.4 and tensorflow 2.7.0. Two types of examples are discussed herein:
a) Five simulation benchmarks, three obtained from SINDYc and the AID and EEG problems introduced in this disclosure. Simulation is used to test the variation of model recovery performance under various severity levels of the constraints.
b) Three real world data available for the example of Lotka Volterra system, the LOIS-P data for AID in pregnancy, and the EEG data for epilepsy. This shows practical applicability of LTC-NN-MR in real world data. All code and data available in supplementary document.

### 5.1 Benchmark Examples

Table 2 shows all examples (physical dynamics are in supplementary document). In the examples marked with (B) in Table 2, there are no external human inputs Uₑₓ apart from control inputs u. The input timing was arbitrarily varied to evaluate effect of input uncertainty constraint C5. For the AID example in simulation, the meal timing is altered. For the EEG example in simulation, a deterministic sinusoidal input was selected and then a stochastic Wiener process-generated input to test for high levels of input uncertainties. In the real-world EEG and AID example, uncertainty is inherent in the data.

### 5.1.1 Automated Insulin Delivery System

In the AID system, the glucose insulin dynamics is given by the Bergman Minimal Model (BMM):

$$i ( \dot{t} ) = - n i ( t ) + {p}_{4} {u}_{1} ( t ) , {i}_{s} ( \dot{t} ) = - {p}_{1} {i}_{s} ( t ) + {p}_{2} ( i ( t ) - {i}_{b} ) \qquad ( 9 )$$

$$G ( \dot{t} ) = - {i}_{s} ( t ) {G}_{b} - p 3 ( G ( t ) ) + u 2 ( t ) / Vol , \qquad ( 10 )$$

The input vector U(t) includes input insulin level u₁(t), which is derived using a self adaptive MPC controller like Tandem Control IQ. Uₑₓ includes the glucose appearance in the body u₂ for a meal. In the real world, users may forget to report the exact timing of the meal and may also make mistakes in estimating consumed carbohydrate amount. This error can be modeled as input uncertainty in time and magnitude. The state vector X(t) comprises of the blood insulin level i, the interstitial insulin level iₛ, and the BG level G. The measured vector Y=G since CGM measures only glucose. p₁, p₂, i_{b}, p₃, p₄, n, and 1/VₒI are all patient specific coefficients.

### 5.1.2 EEG Example

The EEG represents brain waves and can be modeled using system of Duffing-van der Pol oscillators as in Eqn. 11.

$${\ddot{x}}_{1} + {k}_{1} {x}_{1} = {k}_{2} {x}_{2} - {b}_{1} {x}_{3}^{2} - {{b}_{2} ( {x}_{1} - {x}_{2} )}^{3} + {ϵ}_{1} {\dot{x}}_{1} ( 1 - {x}_{1}^{2} ) \\ {\ddot{x}}_{2} - {k}_{2} ( {x}_{1} - {x}_{2} ) = {{b}_{2} ( {x}_{1} - {x}_{2} )}^{3} + {ϵ}_{2} {\dot{x}}_{2} ( 1 - {x}_{2}^{2} ) + μ d W , \qquad ( 11 )$$

where k₁, k₂, b₁, b₂, ϵ₁ and ϵ₂ are patient specific parameters, x₂ is the EEG signal, x₁ is an internal unmeasured state variable, μ is the magnitude of activation, dW is a random variable following the Wiener process. Here the input u=μdW is a stochastic process with significant temporal and magnitude uncertainty.

TABLE 2
Benchmark Examples. (B) denotes examples available from previous benchmark
studies, (N) denotes novel case studies introduced in this disclosure.

| | | | | | | | Max | | |
|---|---|---|---|---|---|---|---|---|---|
| | | | | Uncertain | Nyquist | | sampling | | No of |
| Example | Variables | Inputs | Implicit | timing | rate | | rate | | coe_{f}ficients |
| Real World: Lotka Volterra (B) | x₁, x₂ | 1 | x₁ | No | 2.5 | Hz | 10 | Hz | 4 |
| Simulation: Chaotic Lorenz System (B) | x₁, x₂, x₃ | 1 | x₁ x₂ | No | 100 | Hz | 1000 | Hz | 4 |
| Simulation: F8 Crusader tracking (B) | x₁, x₂, x₃ | 1 | x₂ | No | 100 | Hz | 1000 | Hz | 20 |
| Simulation: Pathogenics attack (B) | x₁, x₂, x₃ x₄, x₅ | 1 | x₃, x₄ | No | 2.8 × 10⁻⁴ | | 5.6 × 10⁻⁴ | | 13 |
| Real world: Autmated Insulin Delivery (N) | Iₛ, G I | 2 | Iₛ, I | Yes | 0.0028 | Hz | 0.0033 | Hz | 9 |
| Simulation: AID (N) | Iₛ, G I | 2 | Iₛ, I | Yes | 0.0028 | Hz | 10 | Hz | 9 |
| Real world: EEG (N) | x₁, x₂, \dot{x}₂, \dot{x}₂ | 1 | x₁, \dot{x}₁ | Yes | 250 | Hz | 500 | Hz | 6 |

### 5.1.3 Real World Data

Three examples of real world data are shown in this disclosure:
A) LOTKA VOLTERRA system uses yearly lynx and hare pelts data collected from Hudson Bay Company.
B) In the real-world AID example, the LOIS-P dataset was used, which includes data from a clinical study on 25 patients with pre-existing T1D for at least a year. All patients were enrolled before 17 weeks gestational age at three sites: Mayo Clinic, Rochester, Mount Sinai in New York City, and Sansum Diabetes Research Institute. On an average 24.7 weeks (±5.2) of Dexcom G6 CGM glucose at 5 mins interval and insulin pump data including insulin and meal intake data.
C) The EEG example is solely evaluated in the real world with the CHB-MIT Scalp EEG database. It has 684 EEG signals from 22 pediatric subjects with epilepsy with a sampling rate of 250 Hz.

### 5.1.4 Simulation Data

Benchmark simulations use data from SINDYc. Simulation data for AID: 14 traces of glucose insulin dynamics were considered, each of which included 200 samples (16 hrs). In each trace, meal ingestion time was varied from [t=15 mins tot=400 min] with carbohydrate value randomly sampled from the range [0 g, 28 g] for each meal, and bolus insulin delivery was sampled from the set [0U, 40U]. The traces were generated using the T1D simulator. Two sampling frequencies are tested: i) 10 Hz, and ii) real world CGM sampling rate of every 5 mins (Table 2).

### 5.2 Baseline Techniques

The system using LTC-NN-MR is compared with the following baseline strategies:

SINDYc: This baseline is used to show that reducing sampling rate to a minimum of Nyquist rate, causes significant degradation of performance for SINDY class of approaches.

NODE-MR: This baseline is the seminal work on neural architecture. It is used to show that lack of a time constant factor in the forward pass (Eqn. 7) reduces accuracy in recovering model.

CT-RNN-MR: This baseline strategy has an input independent time constant factor (Eqn. 7). This is used to show that although time constant factor independent of input in the forward pass cannot accurately recover model from a perturbed system.

### 5.3 Evaluation Experiments and Metrics of Success

For each evaluation experiment, two metrics are considered:

Root mean square error in model coefficients (RMSE_{Θ}): Given the estimated model coefficients Θₑₛₜ.

$${RMSE}_{Θ} = \sqrt{1 / p \times {\sum }_{j = 1 … p} {( {θ}_{est}^{j} - {θ}^{j} )}^{2}} . \qquad ( 12 )$$

Root mean square error in signal (RMSE_{Y}): Given the estimation of the measured variable Yₑₛₜ:

$${RMSE}_{Y} = 1 / n {\sum }_{l = 1 … n} \sqrt{1 / k \times {\sum }_{j = 1 … k} {( {Y}_{est}^{l} ( j ) - {Y}^{l} ( J ) )}^{2}} . \qquad ( 13 )$$

All compared techniques identify sparsity preserving dynamics. Evaluation starts with a configuration Φ₀ that has high sampling rates shown in column 7 of Table 2, has no implicit dynamics, has input perturbation, only uncertainty in input magnitude (no temporal uncertainty). the following evaluation experiments are conducted:

Effect of sampling rate (C1) on (B) examples: The sampling rate of Φ₀ is varied from the rate used in the simulation data to the Nyquist rate (Table 2) and analyze the variation of RMSE_{Θ} and RMSE_{Y}. The configuration with Nyquist sampling rate is denoted as Φ_{N}.

Effect of perturbation (C2) on (B) examples: From Φ_{N}, configuration Φ_{NI} is created by removing the input perturbation from model and data. Effect of perturbation is the difference in performance of Φ_{N} and Φ_{NI}.

Effect of implicit dynamics (C3) on (B) examples: From Φ_{N}, another configuration Φ_{NP} is created where measurements of implicit dynamics are withheld. This experiment compares neural architectures based on their capability in searching for implicit dynamics. Input perturbation was retained. In this comparison, SINDYc is omitted since it is not designed to extract implicit dynamics.

Effect of sparsity (C4): The techniques evaluated herein all maintain sparsity. Hence, C4 is evaluated in conjunction with C3.

Effect of input uncertainty (C5) on (B) and (N) simulation examples: For each case study, the time stamp of input u is varied from 3 samples to 20 samples while keeping the reported time stamp the same.

Real world experiments on AID (N) and EEG (N): The three neural architectures are compared for their performance in modeling real data. For this experiment, the ground truth model coefficients Θ are unknown and the techniques are compared using RMSE_{Y}.

### 5.4 Training and Validation Method

SINDYc: In the experiments, with ϕₙ, the dt variable in the “getTrainingData.m” is changed from the minimum value corresponding to maximum frequency in each example (Table 2) to the Nyquist rate. The Nyquist rate is obtained by computing the power spectral density of the signals sampled at the highest frequency. the frequency f₉₀ at which the cumulative power density reaches 90% of the maximum level is also extracted. The Nyquist rate is two times f₉₀. The dt is changed to obtain four frequency points up to the maximum dt for the Nyquist rate.

Neural Architectures: For evaluation, the neural architectures were implemented starting with a publicly-available codebase where a generic framework applicable to LTC-NN, CT-RNN, and NODE can be implemented using tensorflow 2.7.0. A custom loss function was designed that implements the Runge Kutta solution of the physical dynamics given a vector of model coefficients. The framework can be instantiated with LTC-NN, CT-RNN and NODE core architecture through an input parameter. Batch training was utilized for each example. For each example, the same simulation data as SINDYc was taken, with the traces being divided into 48 instances for training and 16 instances for testing, each instance having at least k=200 samples. These training instances were passed to the neural architectures with a batch size S_{B}=32. The RMSE_{Y} and RMSE_{Θ} are reported on the test data.

### 5.5 Results

First, this section compares SINDYc and all neural architecture on previously-studied benchmark examples. C5 is evaluated with the simulation AID example. Since SINDYc does not model implicit dynamics, only the neural architectures are evaluated for real world AID example.

### 5.5.1 Benchmark Examples

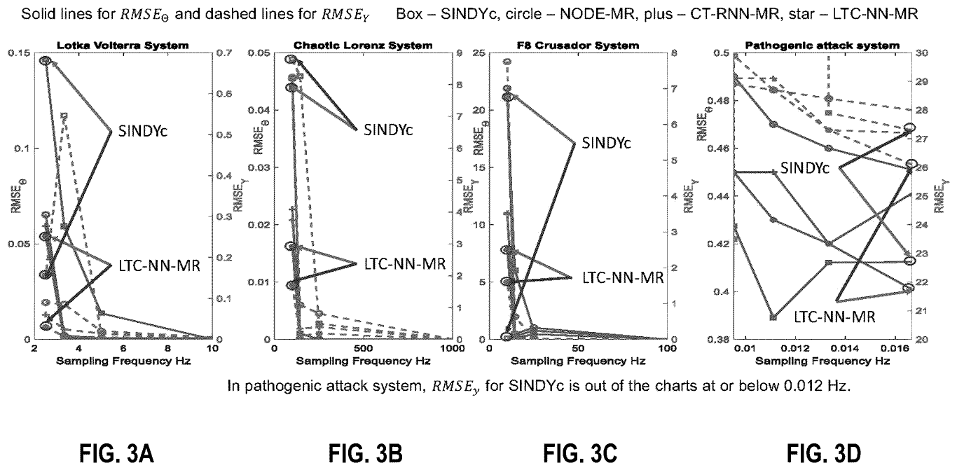

Effect of sampling rate (C1): As seen from FIGS. 3A-3D, at sampling rates nearly four times Nyquist rate, all techniques give similar RMSE_{Θ} and RMSE_{Y}. As sampling rates are increased, every technique appears to show degradation in both the performance metrics. However, SINDYc is most affected by the change in sampling frequency. All neural architectures perform better than SINDYc with LTC-NN-MR showing the best performance. The primary reason for such a result is the fact that as data is sampled less frequently, the set of potential models that fit the data increases. While SINDYc imposes the constraint of sparsity, the neural architectures impose further constraints on top of sparsity through their structure. The most restrictive constraint is the input dependent time constant of LTC-NN-MR and hence it performs the best. CT-RNN-MR has the next most stringent constraint while NODE has the least restrictive constraint among the neural architectures. In all examples except for the pathogenics attack, similar trends are observed for RMSE_{Θ}, where LTC-NN-MR outperforms all neural architectures, which in turn outperforms SINDYc at Nyquist sampling rate. For the pathogenics attack example, an interesting occurrence is observed, where at Nyquist rate, SINDYc has the best performance in both the metrics. However, at the next sampling frequency SINDYc is shown to have a very high RMSE_{Y} for a slight change in RMSE_{Θ}. All neural architectures differed from this trend and showed improvement in both RMSE_{Θ} and RMSE_{Y}. The main reason for this is that SINDYc violates the sparsity constraint (C2). On closer look, SINDYc found a totally different physical model of the system. A hint of this behavior is also seen in the LOTKA-Volterra and F8 Crusader example, where decreasing sampling frequency to Nyquist rate reduced RMSE_{Y} but increased RMSE_{Θ}. Similarly it was observed that SINDYc compensated for loss in RMSE_{Θ} performance by adding extra non-linear terms to reduce RMSE_{y}. From the results, such behavior is not observed for the neural architectures. One main reason can be because ODE Solver at the loss function guides the exploration of the dynamics.

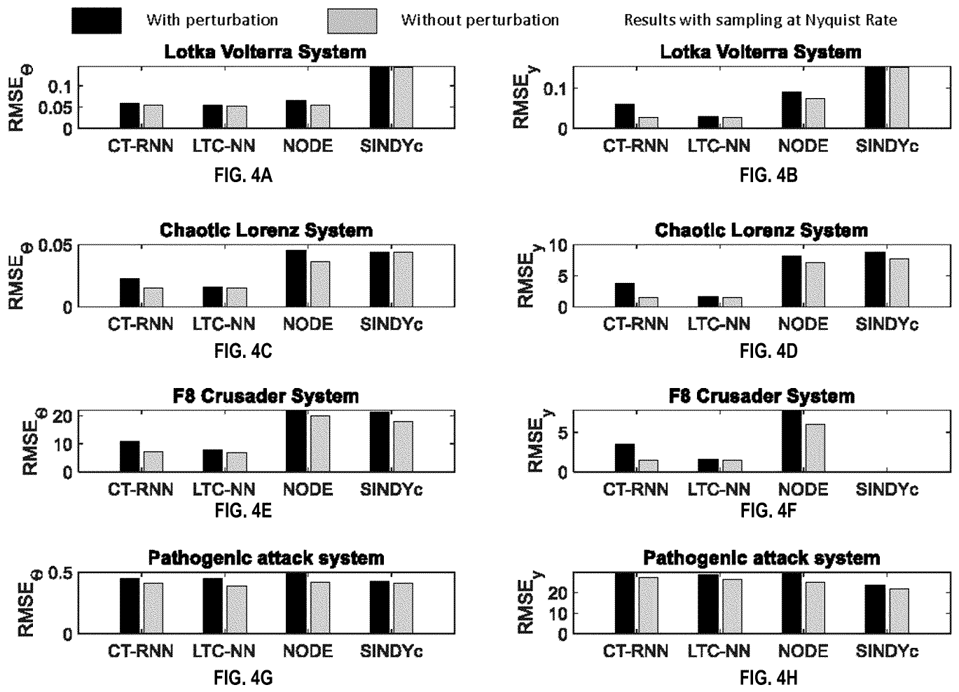

Effect of perturbation (C2): FIGS. 4A-4H show that when input perturbation is removed, all techniques have improved performance in both metrics. Interestingly, CT-RNN-MR without input perturbation is shown to demonstrate similar performance to LTC-NN-MR architecture. This agrees with the theory since, without input the forward pass of CT-RNN-MR and LTC-NN-MR are similar. On the other hand, although NODE-MR had improvement in performance, it could not match CT-RNN-MR and LTC-NN-MR performance for no input perturbation. SINDYc also had performance improvement when input perturbation was removed.

Effect of implicit dynamics (C3+C4): The loss function of each architecture is updated as follows:

$$Loss = 1 / n {\sum }_{i - 1 … n} \sqrt{1 / k {\sum }_{j = 1 … k} {\vert {x}_{i} ( k ) - {x}_{i}^{est} ( k ) \vert}^{2}} , where {x}_{i}^{est} ∈ {X}_{est} = SOLVE ( X ( 0 ) , {θ}_{est} ) . \qquad ( 14 )$$

Table 3 shows that although there is some improvement in both the parameters, it was expected that RMSE_{Θ} should significantly improve by providing measurements of implicit dynamics. However, such improvements were not observed. A possible explanation for this is that since all the baseline examples are observable systems, the implicit dynamics could be derived in terms of the measured system variables. The conjecture is that the neural architectures are capable of modeling the implicit dynamics in terms of the measured variables. This should be further investigated in future works.

Effect of violating input uncertainty (C5): Each input in the benchmark examples were shifted by 2 to 20 samples. However, the model recovery methods were not aware of this change and assumed that the inputs occurred at the designated time. Table 4 shows the average degradation in RMSE_{Y} and RMSE_{Θ} when the input shifts are disabled for LTC-NN-MR. The degradation is significantly reduced when input shifts are re-introduced.

TABLE 3
Effect of providing the measurement of implicit dynamics
to the neural architectures on benchmark examples.

| | | LTC-NN-MR | | CT-RNN-MR | | NODE-MR | |
|---|---|---|---|---|---|---|---|
| Example | RMSE | Implicit | Explicit | Implicit | Explicit | Implicit | Explicit |
| Lotka | RMSE_{Θ} | 0.054 | 0.048 | 0.06 | 0.054 | 0.065 | 0.064 |
| Volterra | RMSE_{Y} | 0.03 | 0.03 | 0.06 | 0.05 | 0.09 | 0.088 |
| Chaotic | RMSE_{Θ} | 0.016 | 0.015 | 0.023 | 0.022 | 0.045 | 0.044 |
| Lorenz | RMSE_{Y} | 1.7 | 1.68 | 3.74 | 3.66 | 8.23 | 8.1 |
| F8 | RMSE_{Θ} | 7.81 | 6.8 | 10.9 | 10.5 | 21.9 | 19.9 |
| Crusader | RMSE_{Y} | 1.6 | 1.57 | 3.52 | 3.46 | 7.75 | 7.22 |
| Pathogenics | RMSE_{Θ} | 0.45 | 0.39 | 0.45 | 0.43 | 0.49 | 0.42 |
| attack | RMSE_{Y} | 28.9 | 28.3 | 29.1 | 28.8 | 29.9 | 29.5 |

TABLE 4
Percentage degradation of RMSE_{Θ}, RMSE_{Y}, for C5 violation
and recovery with input shifts. SC: SINDY-c, LM: LTC-NN-MR,
LV: Lotka Volterra, CL: Lorenz, F8: Crusader: PA: Pathogenics.

| | | | | | RMSE_{Y} + | RMSE_{Θ} + |
|---|---|---|---|---|---|---|
| | RMSE_{Y} | | RMSE_{Θ} | | shifts | shifts |
| Case | SC | LM | SC | LM | LM | LM |
| LV | 120% | 56% | 65% | 53% | 8% | 7% |
| CL | 210% | 121% | 32% | 27% | 13% | 3% |
| F8 | 431% | 212% | 111% | 89% | 13% | 7% |
| PA | 78% | 36% | 24% | 22% | 11% | 6% |

### 5.5.2 Automated Insulin Delivery Example

Simulation Examples: In Table 5, SINDYc did not have any temporal uncertainty for meal inputs. The neural architectures had temporal uncertainty at meal inputs and also used input shifts in the architecture. However, for the last column, the input shift from neural architectures are removed and SINDYc is also evaluated for uncertainty at meal input. All techniques perform well for model recovery from simulation data at 10 Hz sampling rate. SINDYc shows excellent RMSE_{Y} but poor RMSE_{Θ}. The neural architectures perform similar to SINDYc at such high sampling frequency. However, when the sampling rate is reduced to Nyquist rate, all methods have performance degradation, with SINDYc suffering the most. LTC-NN-MR still performs better than the baseline techniques. When input shifts are removed, all techniques suffered significant performance drop.

TABLE 5
Comparison of baseline techniques for AID simulation example
with no implicit dynamics. It also shows effect of input uncertainty
(C5) in last two rows. fₛ is sampling frequency

| | | | | | without | |
|---|---|---|---|---|---|---|
| | fₛ = 10 Hz | | fₛ = 0.0033 Hz | | input shifts | |
| Approach | RMSE_{Y} | RMSE_{Θ} | RMSE_{Y} | RMSE_{Θ} | RMSE_{Y} | RMSE_{Θ} |
| SINDYc | 0.004 | 0.342 | 14.5 | 2.44 | 101.6 | 22.3 |
| LTC-NN-MR | 0.003 | 0.213 | 0.31 | 0.45 | 31.3 | 14.1 |
| CT-RNN-MR | 0.007 | 0.311 | 0.76 | 0.8 | 43.2 | 17.8 |
| NODE-MR | 0.012 | 0.56 | 1.3 | 1.1 | 77.4 | 23.6 |

Real World Example Input Uncertainty (C5): Table 6 shows the performance of the neural architectures on real data. Without exploring temporal uncertainty of inputs, the best RMSE_{Y} obtained for LTC-NN-MR was 26.1. Note that the state of art CGM prediction mechanism for 30 mins ahead prediction has an RMSE of 11.1. With input shift enabled in the architecture, significant improvement in RMSE_{Y} is observed for each neural architecture. For LTC-NN-MR an RMSE_{Y} of 3.03 is observed which is significantly better than state-of-art forecasting mechanisms.

TABLE 6
RMSE_{Y} comparison for AID real world example with sampled data
(C1), control + human perturbed system (C2), sparse dynamics
(C3), implicit dynamics (C4), and input uncertainty (C5).

| Approach | not C5 | C5 |
|---|---|---|
| NODE-MR | 45.6 | 8.7 |
| CT-RNN-MR | 32.3 | 6.8 |
| LTC-NN-MR | 26.1 | 3.03 |

### 5.5.3 EEG Reconstruction Example

Simulation Example: In simulation, a sinusoidal input is used as activation instead of the Wiener process. Table 7 shows that both SINDYc and LTC-NN-MR have comparable accuracy in extracting the model coefficients when measurement of both x₁ and x₂ are available. However, if x₁ measurements are withheld, SINDYc appears to recover an entirely wrong model with high RMSE_{Θ}, whereas LTC-NN-MR has much lower RMSE_{Θ} than SINDYc. Interestingly, if the Wiener process is used as input, then even if x₁ is made available to SINDYc it still recovers a wrong model, which is not the case for LTC-NN-MR.

TABLE 7
RMSE_{Θ} and RMSE_{y} for EEG simulation example

| | Sine input | | Sine input | | Wiener | |
|---|---|---|---|---|---|---|
| | no implicit | | x1 implicit | | input | |
| Approach | RMSE_{Y} | RMSE_{Θ} | RMSE_{Y} | RMSE_{Θ} | RMSE_{Y} | RMSE_{Θ} |
| SINDYc | 0.1 | 0.21 | 23.2 | 46.1 | 144.1 | 101.3 |
| LTC-NN-MR | 0.1 | 0.203 | 6.3 | 4.7 | 19.8 | 12.9 |

Real World Example: Table 8 shows that LTC-NN-MR can replicate the EEG signal with much lower RMSE_{Y} than SINDYc from all patients in the CHB-MIT Scalp EEG dataset.

TABLE 8
RMSE_{y} for EEG real world example

| SINDYc | LTC-NN-MR |
|---|---|
| 1211.3 (±489.1) | 41.2 (±27.9) |

### 5.5.4 Execution Time

For the LTC-NN-MR architecture, the computation complexity of forward pass is O(V+V×(|Θ|+q))+O(|X|N), where N is the number of samples in the data, V, q, Θ, X are described in Section 4. The complexity of backward pass is O(V×P_{LTC}×N+V×(|Θ|+q)×P_{dense}×N), where P_{LTC} is the number of parameters in the LTC cell, and P_{dense} is the number of parameters in each neuron of the dense layer. SINDYc ran on a single CPU thread and was 11.3 (±2.1) times faster than the neural architecture on GPU. However, at in real world data, SINDYc has much poorer performance than LTC-NN-MR. This accuracy time trade-off has to be carefully explored for a given application. Usage of cloud computing may improve the speed for neural architectures and make them a viable candidate for real time accurate model recovery.

### 6 Conclusions

The present disclosure outlines a liquid time constant neural network-based solution to the problem of recovering coefficients of a physics model from real world data from a dynamical system. Five key challenges in real world deployments are identified, along with solutions to mitigate them effectively. The practical challenge of information loss due to low sampling rates (C1) is overcome utilizing the automatic differentiation property of LTC-NN, where each node can reproduce samples with arbitrary precision in between sampling time stamps. LTC-NN-MR handles transients introduced due to discontinuous inputs (C2) by decoupling the input effects from the unperturbed dynamical system through its control affine forward pass dynamics. To derive the sparsest solution (C3), LTC-NN-MR combines ODE solver-based reconstruction loss with dense layer drop out and hence does not need specific knowledge about the underlying equations such as sparsity level as in SINDYc or ground truth model coefficients as in PINNs. LTC-NN-MR is believed to be the only technique to recover model coefficients in presence of implicit dynamics (C4) unlike the weak implicit notions in SINDYc extensions. Further, LTC-NN-MR is believed to be the only technique to be able to recover model in presence of input timing uncertainties making it amenable to be used in human-in-the-loop dynamical systems.

Ethical Considerations: One of the advantages of LTC-NN-MR is that it can recover underlying model without access to measurements of all state variables, hence it can be configured to take into account user privacy norms. On the other hand, one of the applications of LTC-NN-MR is digital twins. An unethical usage is impersonation. Thus, careful ethical evaluation is required when integrating such systems in medical practice.

### 7 Computer-Implemented System

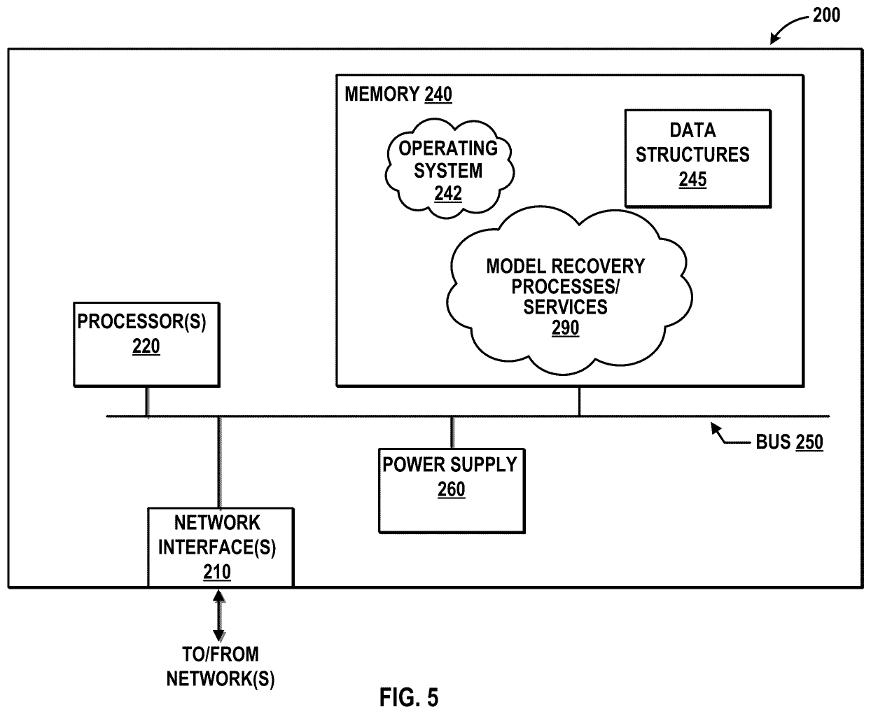

FIG. 5 is a schematic block diagram of an example computing device 200 that may be used with one or more embodiments described herein, e.g., implementing aspects of the system shown in FIG. 1.

Computing device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, computing device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system 100 and associated methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes computing device 200 by, inter alia, invoking operations in support of software processes and/or services executing on the device. These software processes and/or services may include model recovery processes/services 290, which can include aspects of the methods discussed herein with respect to the system 100 of FIG. 2 and/or implementations of various modules described herein. Note that while model recovery processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the model recovery processes/services 290 is shown as a standalone process, those skilled in the art will appreciate that this process may be executed as a routine or module within other processes.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

### 8A Lotka Volterra Model

It has two variables x₁ and x₂ given by the following equations:

$${\dot{x}}_{1} = {ax}_{1} - {bx}_{1} {x}_{2} \qquad ( 15 )$$

$${\dot{x}}_{2} = - {cx}_{2} + {dx}_{1} {x}_{2} + u \qquad ( 16 )$$

a=0.5, b=0.025, c=0.5, and d=0.005

### 8B Chaotic Lorenz System

The chaotic lorenz system is described in the following equations:

$${\dot{x}}_{1} = σ ( {x}_{2} - {x}_{1} ) + u \qquad ( 17 )$$

$${\dot{x}}_{2} = {x}_{1} ( ρ - {x}_{3} ) - {x}_{2} \qquad ( 18 )$$

$${\dot{x}}_{3} = {x}_{1} {x}_{2} - β {x}_{3} \qquad ( 19 )$$

σ=10, β=8/3, ρ=28.
   8C F8 Crusader system

The F8 Crusader system is given by

$${\dot{x}}_{1} = - 0.877 {x}_{1} + {x}_{3} - 0.088 {x}_{1} {x}_{3} + \qquad ( 20 )$$

$$0.47 {x}_{1}^{2} - 0.019 {x}_{2}^{2} - {x}_{1}^{2} {x}_{3} + \qquad ( 21 )$$

$$0.846 {x}_{1}^{3} - 0.215 u + 0.28 {x}_{1}^{2} u + \qquad ( 22 )$$

$$0.47 {x}_{1} {u}^{2} + 0.63 {u}^{3} \qquad ( 23 )$$

$${\dot{x}}_{2} = {x}_{3} \qquad ( 24 )$$

$${\dot{x}}_{3} = - 4.208 {x}_{1} - 0.396 {x}_{3} - \qquad ( 25 )$$

$$0.47 {x}_{1}^{2} - 3.564 {x}_{1}^{3} - \qquad ( 26 )$$

$$20.967 u + 6.265 {x}_{1}^{2} u + \qquad ( 27 )$$

$$46 {x}_{1} {u}^{2} + 61.1 {u}^{3} \qquad ( 28 )$$

### 8D Pathogenic Attack System

The pathogenic attack system is given by the following equations:

$${\dot{x}}_{1} = λ - d {x}_{1} - β ( 1 - η u ) {x}_{1} {x}_{2} \qquad ( 29 )$$

$${\dot{x}}_{2} = β ( 1 - η u ) {x}_{1} {x}_{2} - a {x}_{2} - {p}_{1} {x}_{4} {x}_{2} - {p}_{2} {x}_{5} {x}_{2} \qquad ( 30 )$$

$${\dot{x}}_{3} = {c}_{2} {x}_{1} {x}_{2} {x}_{3} - {c}_{2} q {x}_{2} {x}_{3} - {b}_{2} {x}_{3} \qquad ( 31 )$$

$${\dot{x}}_{4} = {c}_{1} {x}_{2} {x}_{4} - {b}_{1} {x}_{4} \qquad ( 32 )$$

$${\dot{x}}_{5} = {c}_{2} q {x}_{2} {x}_{4} - h {x}_{5} , \qquad ( 33 )$$

with λ=1, d=0.1, β=1, α=0.2, p₁=1, p₂=1, c₁=0.03, c₂=0.06, b₁=0.1, b₂=0.01, q=0.5, h=0.1, and η=0.9799.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for recovery of model of a dynamical system based on measurement data having a low sampling rate, comprising:
a processor in communication with a memory, the memory including instructions executable by the processor to:
access measurement data including a set of traces over time for a dynamical system, the set of traces being sampled at a sampling frequency;
apply the measurement data as input to a neural architecture embodied at the processor, the neural architecture having a forward pass configuration that correlates with a bilinear approximation of a set of implicit dynamics of the dynamical system;
extract a set of hidden states associated with the measurement data by a plurality of nodes of the neural architecture; and
transform, at a dense layer of the neural architecture, the set of hidden states into a set of model coefficient estimates and a set of input shift values that correlate with an over-determined system of equations descriptive of the set of implicit dynamics, the set of model coefficient estimates corresponding with a recovered model of the dynamical system.

2. The system of claim 1, the dense layer including a plurality of dense layer nodes whose outputs are used to shift an input vector corresponding with the measurement data that includes a set of user-initiated control inputs (Uₑₓ) applied to the dynamical system over time by a user, the set of user-initiated control inputs (Uₑₓ) having an unknown error and a corresponding set of measured user input activation times having an unknown error.

3. The system of claim 1, the dense layer incorporating dropout to reflect sparsity inherent in the implicit model and the set of measurement data.

4. The system of claim 1, the set of traces including:
a set of output measurements (Y) of the dynamical system over time including an initial condition value (Y(0)) of the set of output measurements;
a set of system-initiated control inputs (U) applied by the dynamical system over time; and
a set of user-initiated control inputs (Uₑₓ) applied to the dynamical system over time by a user.

5. The system of claim 1, the memory further including instructions executable by the processor to:
apply the set of model coefficient estimates, the set of input shift values, and one or more instances of the set of traces as input to an ordinary differential equation solver of the neural architecture resulting in a set of estimated output measurements (Yₑₛₜ); and
evaluate a loss between the set of estimated output measurements (Yₑₛₜ) and a set of output measurements (Y) of the set of traces.

6. The system of claim 5, the ordinary differential equation solver incorporating a Runge Kutta integration method.

7. The system of claim 6, the memory further including instructions executable by the processor to:
iteratively update the set of model coefficient estimates to minimize the loss.

8. The system of claim 1, the sampling frequency being less than a generalization boundary that correlates with a sampling frequency threshold where generalization error associated with a model learning method is higher than generalization error associated with a model recovery method.

9. The system of claim 6, the sampling frequency being equal to a Nyquist rate.

10. The system of claim 1, the neural architecture being a liquid time constant neural network architecture.
